(19) United States
(12) Patent Application Publication
(10) Pub. No.: US 2025/0340202 A1
(43) Pub. Date: Nov. 6, 2025

(54) AUTOMATIC UNPARKING APPARATUS AND METHOD

(71) Applicant: HYUNDAI MOBIS CO., LTD., Seoul (KR)

(72) Inventor: Seung Jae KIM, Yongin-si (KR)

(73) Assignee: HYUNDAI MOBIS CO., LTD., Seoul (KR)

(21) Appl. No.: 19/190,160

(22) Filed: Apr. 25, 2025

(30) Foreign Application Priority Data
May 2, 2024 (KR) 10-2024-0058527

(51) Int. Cl. B60W 30/06; B60W 60/00; G06V 20/58; G06V 40/16; G07C 9/28

(52) U.S. Cl. CPC B60W 30/06; B60W 60/001; G06V 20/58; G06V 40/172; G07C 9/28; B60W 2540/221

(57) ABSTRACT

An automatic unparking apparatus includes a camera sensor configured to obtain body information of a driver by measuring a shape of the driver's body, a distance sensor configured to detect an object located around a vehicle, and measure a distance from the vehicle to the detected object, a communication device configured to transmit and receive signals with a smart key corresponding to the vehicle, a controller configured to identify a driver approaching the vehicle, determine whether the driver can enter a driver's seat of the vehicle, determine whether the driver can enter through a driver's seat door of the vehicle based on a determination that the driver can enter the driver's seat, and provide an automatic unparking operation suggestion notification, based on a determination that the driver cannot enter through the driver's seat door, and a warning output device configured to output the automatic unparking operation suggestion notification.

### CROSS-REFERENCE TO RELATED APPLICATIONS

This application claims the benefit under 35 USC § 119(a) of Korean Patent Application No. 10-2024-0058527, filed on May 2, 2024, in the Korean Intellectual Property Office, the entire disclosure of which is incorporated herein by reference for all purposes.

### BACKGROUND

### 1. Field

The following description relates to a vehicle including an autonomous driving operation, and more particularly, to a vehicle to which an automatic unparking operation is applied.

### 2. Description of Related Art

Recently, vehicles have become a necessity for modern people, and as the number of vehicles in operation has rapidly increased, various social problems, such as traffic congestion and parking problems, have arisen.

Particularly, in limited areas, such as big cities, as the number of vehicles increases, parking spaces where vehicles can be parked have inevitably decreased, and in order to solve this shortage of parking spaces, parking areas that are designated for one vehicle are becoming increasingly narrow.

Accordingly, a gap between parked vehicles is narrow, and in this case, it is becoming difficult for drivers to visually confirm surrounding obstacles and drive their vehicles to park in, or unpark from, narrow parking areas. Particularly, for inexperienced drivers, it is difficult not only to park vehicles in narrow parking areas, but also to unpark the vehicles from the narrow parking areas.

As automobile technology has advanced rapidly, technology for various convenience devices for driver convenience has been steadily developed, in addition to parking assistance systems that assist drivers in parking, unparking assistance systems that assist drivers in safely unparking parked vehicles have also been developed.

Particularly, recently, an unparking assistance system that allows a driver to unpark a vehicle even in a state in which the driver is outside the vehicle has been developed.

The typical unparking assistance system is a system that recognizes a parking space based on distance information from surrounding obstacles measured by front/rear/side ultrasonic sensors and automatically controls steering, vehicle speed, and gear shifting without driver operation of a steering wheel to unpark a vehicle, and the unparking assistance system performs parking in a target space and unparking from the space based on the position and size of the parking space recognized through the sensors provided in the unparking assistance system, but there was a problem in that a distance from a neighboring parked vehicle and the driver's body size were not considered.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an automatic unparking apparatus includes a camera sensor configured to obtain body information of a driver by measuring a shape of the driver's body; a distance sensor configured to detect an object located around a vehicle, and measure a distance from the vehicle to the detected object; a communication device configured to transmit and receive signals with a smart key corresponding to the vehicle; a controller configured to identify a driver approaching the vehicle, determine whether the driver can enter a driver's seat of the vehicle, determine whether the driver can enter through a driver's seat door of the vehicle based on a determination that the driver can enter the driver's seat, and provide an automatic unparking operation suggestion notification based on a determination that the driver cannot enter through the driver's seat door; and a warning output device configured to output the automatic unparking operation suggestion notification.

The controller may be further configured to measure the body information of the driver with the camera sensor as the driver approaches the vehicle; determine whether the measured driver's body information is present in pre-stored driver's body information; primarily identify the driver with the smart key, upon determining that the measured driver's body information is present in the pre-stored driver's body information; secondarily identify the driver based on at least one of driver's face recognition information and driver's stride recognition information obtained by the camera sensor; and activate the pre-stored driver's body information based on the secondarily identified driver.

The controller may be further configured to collect and store the body information of the driver approaching the vehicle, based on a determination that the body information of the driver approaching the vehicle is not present in the pre-stored driver's body information.

The controller may be further configured to provide the automatic unparking operation suggestion notification based on a determination that the driver cannot enter the driver's seat.

The controller may be further configured to provide an automatic unparking operation non-execution suggestion notification based on a determination that the driver can enter through the driver's seat door.

In a general aspect, an automatic unparking method includes identifying a driver approaching a vehicle; determining whether the driver can enter a driver's seat of the vehicle; determining whether the driver can enter through a driver's seat door, based on a determination that the driver can enter the driver's seat; and providing an automatic unparking operation suggestion notification, based on a determination that the driver cannot enter through the driver's seat door.

The identifying the driver approaching the vehicle may include measuring body information of the driver approaching the vehicle with a camera sensor; determining whether the measured driver's body information is present in pre-stored driver's body information; primarily identifying the driver with a smart key, upon determining that the measured driver's body information is present in the pre-stored driver's body information; secondarily identifying the driver based on at least one of driver's face recognition information and driver's stride recognition information obtained by the camera sensor; and activating the pre-stored driver's body information based on the secondarily identified driver.

The method may further include collecting and storing the body information of the driver approaching the vehicle, based on a determination that the body information of the driver approaching the vehicle is not present in the pre-stored driver's body information.

The method may further include providing the automatic unparking operation suggestion notification, based on a determination that the driver cannot enter the driver's seat.

The method may further include providing an automatic unparking operation non-execution suggestion notification based on a determination that the driver can enter through the driver's seat door.

Other features and aspects will be apparent from the following detailed description, the drawings, and the claims.

### BRIEF DESCRIPTION OF DRAWINGS

FIG. 1 illustrates a block diagram of the entirety of an autonomous driving control system to which an autonomous driving apparatus is applied, in accordance with one or more embodiments.

FIG. 2 illustrates an example application of the autonomous driving apparatus to an autonomous vehicle, in accordance with one or more embodiments.

FIG. 3 illustrates a block diagram of an autonomous unparking apparatus in accordance with one or more embodiments.

FIG. 4 illustrates a method of measuring a driver's body information, in accordance with one or more embodiments.

FIG. 5, FIG. 6, FIG. 7, and FIG. 8 are diagrams each illustrating a method of determining whether to suggest an automatic unparking operation, in accordance with one or more embodiments.

FIG. 9 is a flowchart illustrating a method of identifying a driver, in accordance with one or more embodiments.

FIG. 10 is a flowchart illustrating a method of operating the automatic unparking operation, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide an automatic unparking apparatus that assists in the unparking of a vehicle based on a distance from surrounding vehicles and the driver's body size in addition to the automatic unparking operation.

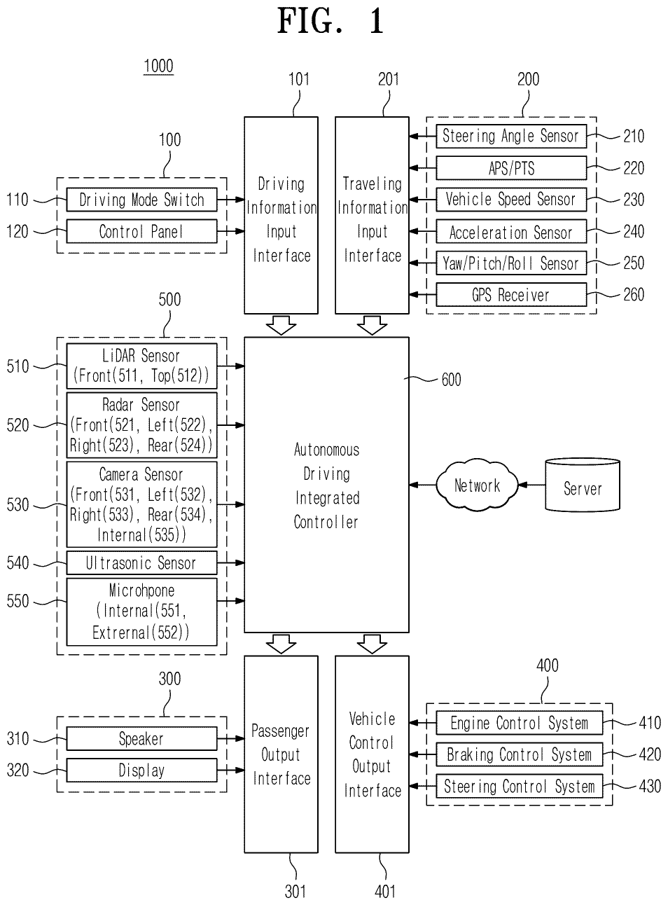

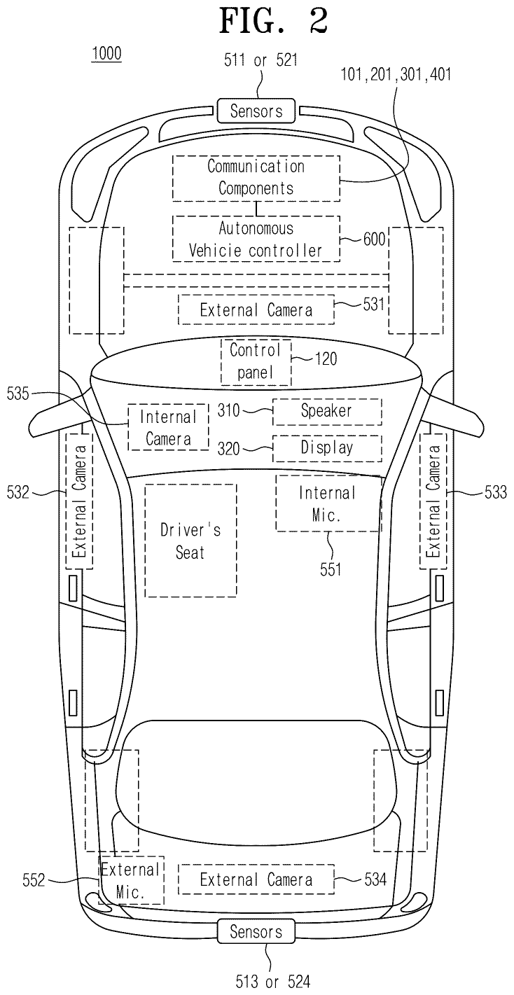

FIG. 1 is an overall block diagram of an autonomous driving control system to which an autonomous driving apparatus is applicable, in accordance with one or more embodiments. FIG. 2 is a diagram illustrating an example in which an autonomous driving apparatus is applied to a vehicle, in accordance with one or more embodiments.

First, a structure and operation of an autonomous driving control system (e.g., an autonomous driving vehicle) to which an autonomous driving apparatus is applicable, in accordance with one or more embodiments, will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, a passenger output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input device 100 in an autonomous driving mode or manual driving mode of a vehicle. As illustrated in FIG. 1, the user input device 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as vehicle speed, acceleration, a yaw, a pitch, and a roll formed in the vehicle. The traveling information may be detected by a traveling information detection device 200, including a steering angle sensor 210, an accelerator position sensor (APS)/pedal travel sensor (PTS) 220, a vehicle speed sensor 230, an acceleration sensor 240, a yaw/pitch/roll sensor 250, and a global positioning system (GPS) receiver 260, as illustrated in FIG. 1.

Furthermore, the traveling information of the vehicle may include location information of the vehicle. The location information of the vehicle may be obtained through the global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output device 300 through the occupant output interface 301 in the autonomous driving mode or manual driving mode of the vehicle. That is, the autonomous driving integrated controller 600 transmits the driving state information of the vehicle to the output device 300 so that the occupant may check the autonomous driving state or manual driving state of the vehicle based on the driving state information output through the output device 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output device 300 through the occupant output interface 301 so that the output device 300 may output a warning to the driver. In order to output such driving state information and warning information acoustically and visually, the output device 300 may include a speaker 310 and a display 320 as illustrated in FIG. 1. In this example, the display 320 may be implemented as the same device as the control panel 120, or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600, in accordance with one or more embodiments, may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output device 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. Accordingly, as illustrated in FIG. 1, the autonomous driving apparatus, in accordance with one or more embodiments, may include a sensor device 500 that detects a nearby object of the vehicle, such as a nearby vehicle, pedestrian, road, or fixed facility (e.g., a signal light, a signpost, a traffic sign, or a construction fence).

The sensor device 500 may include, as examples, one or more of a LIDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle, and detect a nearby object outside the vehicle by receiving a signal reflected and returned from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 that captures the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output device 300.

As illustrated in FIG. 1, the sensor device 500 may further include an ultrasonic sensor 540 in addition to the LiDAR sensor 510, the radar sensor 520, and the camera sensor 530 and further adopt various types of sensors to detect a nearby object of the vehicle along with the sensors.

FIG. 2 illustrates an example in which, in order to aid in understanding the one or more examples, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor device 500 may further include a bio sensor that detects bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor device 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar operations as those illustrated in FIG. 1. FIG. 2 illustrates in more detail a relative positional relationship of each component (based on the interior of the autonomous driving vehicle 1000) as compared with FIG. 1.

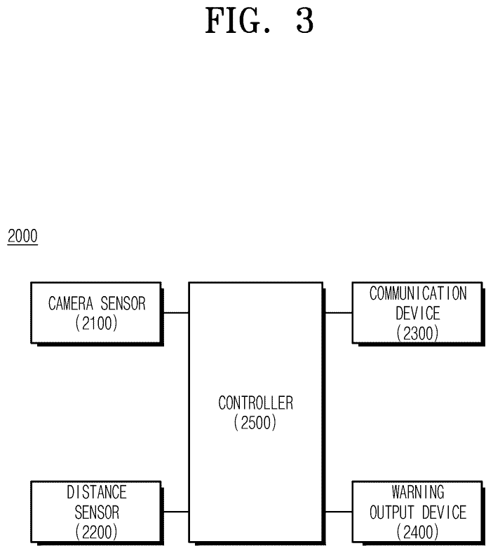

FIG. 3 is a block diagram illustrating an autonomous unparking apparatus, in accordance with one or more embodiments.

Referring to FIG. 3, an automatic unparking apparatus 2000 may include camera sensors 2100, distance sensors 2200, a communication device 2300, a warning output device 2400, and a controller 2500.

The camera sensor 2100 may measure the body shape of a driver approaching a vehicle 1000. The camera sensors 2100 may measure skeleton information of the driver approaching the vehicle 1000. Through this, the camera sensor 2100 may measure driver's body information.

For this purpose, the camera sensors 2100 may be disposed at the upper ends of both sides of the front surface and the center of the rear surface of the vehicle 1000. For example, the driver approaching the vehicle 1000 may be detected through an SVM based on the camera sensors 2100.

The distance sensors 2200 may detect objects located around the vehicle 1000. For example, the objects may include other vehicles, obstacles, and the like located around the vehicle 1000.

The distance sensors 2200 may detect objects located around the vehicle 1000. For example, the distance sensors 2200 may include lidar sensors, radar sensors, and the like.

The distance sensors 2200 may measure a distance to the detected object.

The distance sensors 2200 may be disposed on front/rear bumpers of the vehicle 1000 and the centers of driver's seat/front passenger seat doors.

The communication device 2300 may transmit and receive signals through communication with a driver's smartphone/smart key.

Further, the communication device 2300 may receive vehicle information around the vehicle 1000 through a vehicle-to-vehicle (V2V) communication device. The communication device 2300 may receive a distance to a vehicle located around the vehicle 1000 through vehicle-to-vehicle communication through the V2V communication device.

The warning output device 2400 may include a display configured to deliver visual information to passengers and a speaker configured to deliver auditory information.

The warning output device 2400 may output at least one of an automatic unparking operation suggestion notification or an automatic unparking operation non-execution suggestion notification.

The controller 2500 may collect automatic unparking information through at least one of the camera sensors 2100, the distance sensors 2200, or the communication device 2300. For example, the automatic unparking information may include driver's body information and object distance information.

The controller 2500 may identify the driver approaching the vehicle 1000 through the camera sensors 2100.

For this purpose, the controller 2500 may measure the body information of the driver approaching the vehicle 1000 through the camera sensors 2100. The controller 2500 may determine whether the measured driver's body information is present in pre-stored driver's body information.

For example, if the measured driver's body information is present in the pre-stored driver's body information, the controller 2500 may primarily identify the driver through the smart key. The controller 2500 may secondarily identify the driver based on at least one of driver's face recognition information or driver's stride recognition information acquired through the camera sensors 2100. The controller 2500 may activate the pre-stored driver's body information in response to the secondarily identified driver. On the other hand, if the driver's body information of the approaching driver is not present in the pre-stored driver's body information, the controller 2500 may collect and store the body information of the approaching driver.

In addition, the controller 2500 may determine whether the driver is capable of entering the driver's seat of the vehicle 1000. That is, the controller 2500 may determine whether the driver can or cannot enter the driver's seat of the vehicle 1000.

It the driver is not capable of entering (or cannot enter) the driver's seat, the controller 2500 may provide the automatic unparking operation suggestion notification through the warning output device 2400.

On the other hand, if the driver is capable of entering the driver's seat, the controller 2500 may determine whether the driver is capable of entering (or can enter) through the driver's seat door. Thereafter, if the driver is not capable of entering (or cannot enter) through the driver's seat door, the controller 2500 may provide the automatic unparking operation suggestion notification through the warning output device. On the contrary, if the driver is capable of entering (or can enter) through the driver's seat door, the controller 2500 may provide the automatic unparking operation non-execution suggestion notification.

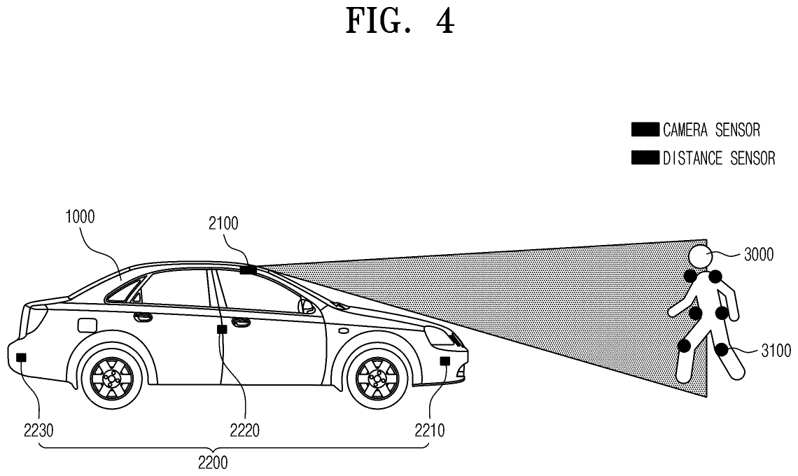

FIG. 4 is a diagram illustrating a method of measuring a driver's body information, in accordance with one or more embodiments.

Referring to FIG. 4, the automatic unparking apparatus 2000 may identify a driver approaching the vehicle 1000 to board the vehicle 1000. The automatic unparking apparatus 2000 may collect skeleton information 3100 of a passenger 3000 using the camera sensors 2100. The skeleton information 3100 may include at least one of knee height information or shoulder width information of the passenger 3000.

If the driver is located outside a vehicle sensor detection range and it is difficult to detect the driver using vehicle sensors, the automatic unparking apparatus 2000 may confirm that the driver is approaching the vehicle 1000 by checking the communication device 2300 of the vehicle 1000 and a driver's device (smartphone and smart key) using wireless communication.

If the driver comes within the vehicle sensor detection range, the automatic unparking apparatus 2000 may detect a degree (distance) of the driver's approach to the vehicle 1000 using the vehicle sensors (for example, the camera sensors 2100 and the distance sensors 2200).

For this purpose, the automatic unparking apparatus 2000 may gradually identify the driver when the driver approaches within the vehicle sensor detection range

If the driver enters the vehicle sensor detection range, the automatic unparking apparatus 2000 may primarily identify the driver through communication with the driver's smartphone/smart key.

If a distance between the driver and the vehicle 1000 is within a predetermined distance after the driver has entered the vehicle sensor detection range, the automatic unparking apparatus 2000 may secondarily identify the driver through the camera sensors 2100. For example, the distance between the driver and the vehicle 1000 for secondary driver identification may be within 3 m.

Further, the automatic unparking apparatus 2000 may collect body size information of the driver approaching the vehicle 1000.

If there is no pre-stored information about the driver approaching the vehicle 1000, the automatic unparking apparatus 2000 may confirm the body size of the approaching driver using the camera sensors 2100 of the vehicle 1000.

If there is pre-stored information about the driver approaching the vehicle 1000, the automatic unparking apparatus 2000 may perform primary driver identification using the driver's smartphone or the smart key, and perform secondary driver identification using the driver's face recognition information and/or the driver's stride recognition information recognized through the skeleton information.

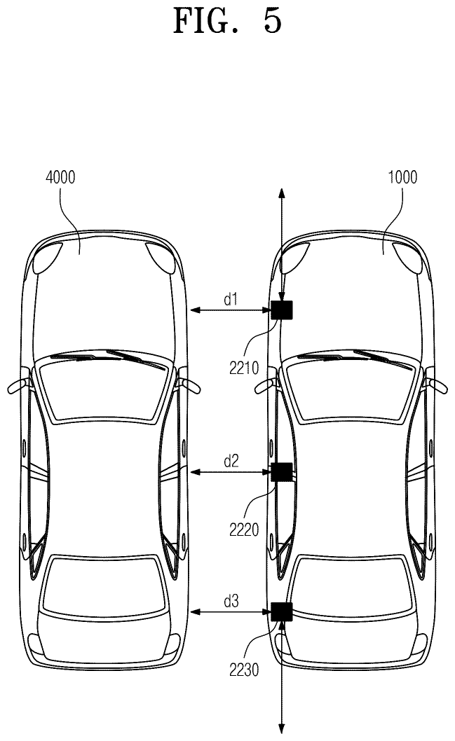

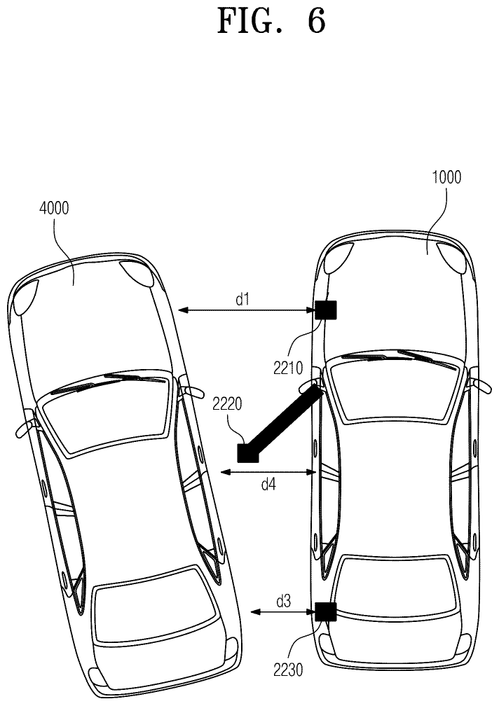

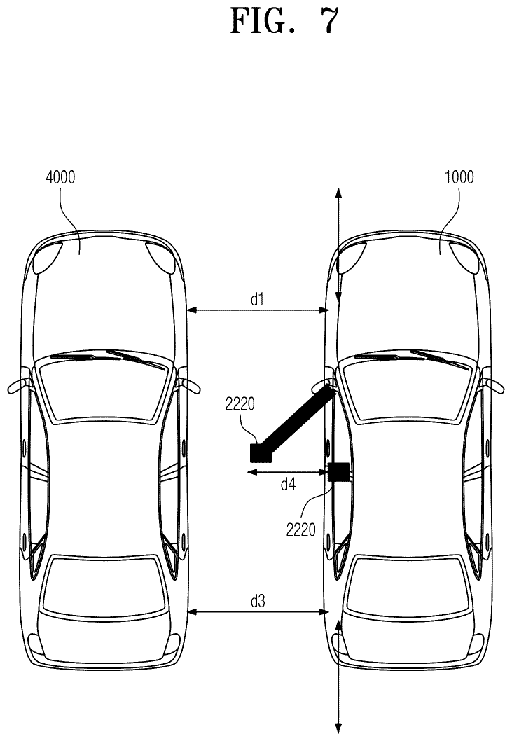

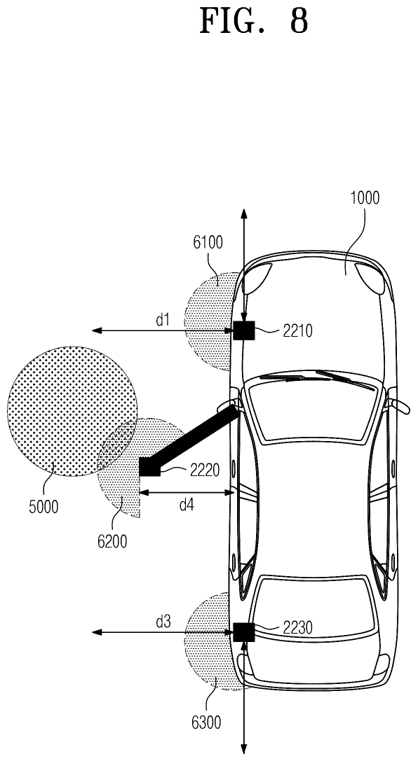

FIGS. 5 to 8 are diagrams each illustrating a method of determining whether to suggest the automatic unparking operation, in accordance with one or more embodiments.

Referring to FIG. 5, if a driver approaches the vehicle 1000 to board the vehicle 1000, the automatic unparking apparatus 2000 may confirm distances to an obstacle around the vehicle 1000 or a neighboring vehicle 4000 using the distance sensors 2200.

The automatic unparking apparatus 2000 may confirm the distances to the obstacle around the vehicle 1000 or the distance to the neighboring vehicle 4000 in a state in which the doors of the vehicle 1000 are closed.

The automatic unparking apparatus 2000 may confirm the distances to the obstacle or the neighboring vehicle 4000 using, as an example, three distance sensors 2210, 2220, and 2230.

For example, the automatic unparking apparatus 2000 may confirm a first distance d1 between the vehicle 1000 and the neighboring vehicle 4000 or the obstacle through the first distance sensor 2210. The automatic unparking apparatus 2000 may confirm a second distance d2 between the vehicle 1000 and the neighboring vehicle 4000 or the obstacle through the second distance sensor 2220. The automatic unparking apparatus 2000 may confirm a third distance d3 between the vehicle 1000 and the neighboring vehicle 4000 or the obstacle through the third distance sensor 2230.

The automatic unparking apparatus 2000 may determine whether the driver is capable of entering the driver's seat by comparing a driver's body size with the distances between the vehicle 1000 and the neighboring vehicle 4000.

If the distances d1, d2, and d3 between the vehicle 1000 and the neighboring vehicle 4000 are less than the driver's body size, the automatic unparking apparatus 2000 may determine that the driver is not capable of entering the driver's seat. Thereafter, if the driver is not capable of entering the driver's seat, the automatic unparking apparatus 2000 may provide an automatic unparking operation suggestion notification.

Referring to FIG. 6, if a driver approaches the vehicle 1000 to board the vehicle 1000, the automatic unparking apparatus 2000 may confirm distances to an obstacle around the vehicle 1000 or a neighboring vehicle 4000 using the distance sensors 2200.

The automatic unparking apparatus 2000 may confirm the distances to the neighboring vehicle 4000 in a state in which a door of the vehicle 1000 is open.

The automatic unparking apparatus 2000 may confirm distances to the neighboring vehicle 4000 using, as an example, the three distance sensors 2210, 2220, and 2230.

For example, the automatic unparking apparatus 2000 may confirm the first distance d1 between the vehicle 1000 and the neighboring vehicle 4000 or the obstacle through the first distance sensor 2210. The automatic unparking apparatus 2000 may confirm the third distance d3 between the vehicle 1000 and the neighboring vehicle 4000 or the obstacle through the third distance sensor 2230. The automatic unparking apparatus 2000 may confirm a fourth distance d4, i.e., a distance between the door and the main body of the vehicle 1000 through the second distance sensor 2220. Here, the fourth distance d4 may be the width of opening of the driver's seat door of the vehicle 1000 in the opened state of the door.

The automatic unparking apparatus 2000 may determine whether the driver is capable of entering the driver's seat by comparing a driver's body size with the distances between the vehicle 1000 and the neighboring vehicle 4000.

If the first distance d1 exceeds the driver's body size and the third distance d3 is less than the driver's body size, the automatic unparking apparatus 2000 may determine that the driver is capable of entering the driver's seat. Thereafter, the driver may enter the driver's seat, but if the width d4 of opening of the driver's seat door is less than the driver's body size, the automatic unparking apparatus 2000 may provide an automatic unparking operation suggestion notification.

Referring to FIG. 7, if a driver approaches the vehicle 1000 to board the vehicle 1000, the automatic unparking apparatus 2000 may confirm distances to an obstacle around the vehicle 1000 or a neighboring vehicle 4000 using the distance sensors 2200.

The automatic unparking apparatus 2000 may confirm the distances to the neighboring vehicle 4000 in a state in which a door of the vehicle 1000 is open.

The automatic unparking apparatus 2000 may confirm the distances to the neighboring vehicle 4000 using, as an example, the three distance sensors 2210, 2220, and 2230.

For example, the automatic unparking apparatus 2000 may confirm the first distance d1 between the vehicle 1000 and the neighboring vehicle 4000 or the obstacle through the first distance sensor 2210. The automatic unparking apparatus 2000 may confirm the third distance d3 between the vehicle 1000 and the neighboring vehicle 4000 or the obstacle through the third distance sensor 2230. The automatic unparking apparatus 2000 may confirm the fourth distance d4, i.e., the distance between the door and the main body of the vehicle 1000 through the second distance sensor 2220. Here, the fourth distance d4 may be the width of opening of the driver's seat door of the vehicle 1000 in the opened state of the door.

The automatic unparking apparatus 2000 may determine whether the driver is capable of entering the driver's seat by comparing a driver's body size with the distances between the vehicle 1000 and the neighboring vehicle 4000.

If the first distance d1 exceeds the driver's body size and the third distance d3 exceeds the driver's body size, the automatic unparking apparatus 2000 may determine that the driver is capable of entering the driver's seat. Thereafter, the driver may enter the driver's seat, and if the width d4 of opening of the driver's seat door is greater than or equal to the driver's body size, the automatic unparking apparatus 2000 may not provide an automatic unparking operation suggestion notification.

Referring to FIG. 8, if a driver approaches the vehicle 1000 to board the vehicle 1000, the automatic unparking apparatus 2000 may confirm distances to an obstacle 5000 around the vehicle 1000 or a neighboring vehicle 4000 using the distance sensors 2200.

The automatic unparking apparatus 2000 may confirm the distances to the obstacle 5000 around the vehicle 1000 using, as an example, the three distance sensors 2210, 2220, and 2230.

For example, the automatic unparking apparatus 2000 may confirm the first distance d1 between the vehicle 1000 and the obstacle 5000 around the vehicle 1000 through the first distance sensor 2210. The automatic unparking apparatus 2000 may confirm the fourth distance d4, i.e., the distance between a door and the main body of the vehicle 1000 through the second distance sensor 2220. Here, the fourth distance d4 may be the width of opening of the driver's seat door of the vehicle 1000 in the opened state of the door. The automatic unparking apparatus 2000 may confirm the third distance d3 between the vehicle 1000 and the obstacle 5000 around the vehicle 1000 through the third distance sensor 2230.

In addition, the automatic unparking apparatus 2000 may confirm whether there is an obstacle using, as an example, the three distance sensors 2210, 2220, and 2230.

For example, the first distance sensor 2210 may sense whether the obstacle 5000 is located within a sensing radius 6100. The second distance sensor 2220 may sense whether the obstacle 5000 is located within a sensing radius 6200. The third distance sensor 2230 may sense whether the obstacle 5000 is located within a sensing radius 6300.

For example, if the obstacle 5000 is located within the sensing radius 6200 of the second distance sensor 2220, the automatic unparking apparatus 2000 may determine that the obstacle 5000 is located around the door of the vehicle 1000.

The automatic unparking apparatus 2000 may confirm whether the door is capable of being opened based on the obstacle 5000 around the door of the vehicle 1000.

The automatic unparking apparatus 2000 may determine whether the driver is capable of entering the driver's seat by comparing a driver's body size with distance information between the door and the main body of the vehicle 1000.

For example, if at least one of the first distance d1 or the third distance d3 exceeds the driver's body size, the automatic unparking apparatus 2000 may determine that the driver is capable of entering the driver's seat.

Thereafter, the driver may enter the driver's seat, and if the width d4 of opening of the door on the driver's seat side is greater than or equal to the driver's body size, the automatic unparking apparatus 2000 may provide an automatic unparking operation suggestion notification to the driver through a driver's smartphone.

For example, if the fourth distance d4 is less than the driver's body size, the automatic unparking apparatus 2000 may determine that the driver is not capable of entering the driver's seat. Thereafter, the automatic unparking apparatus 2000 may provide an automatic unparking operation non-execution suggestion notification to the driver through the driver's smartphone.

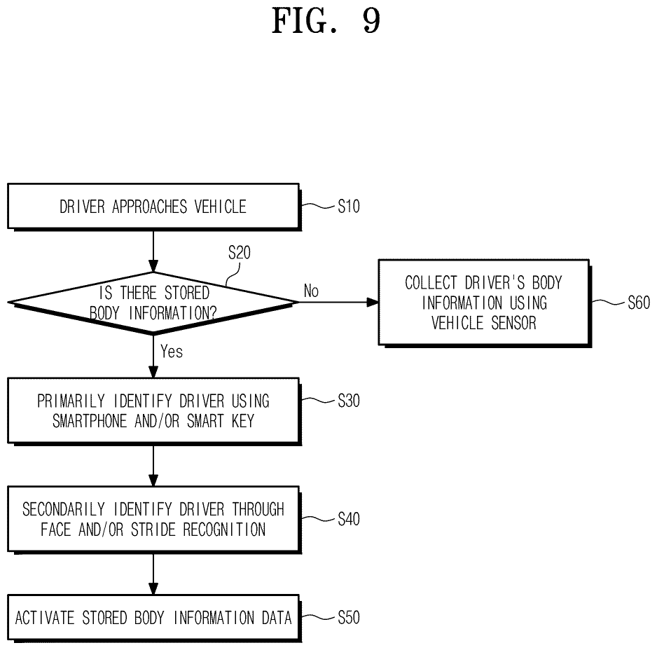

FIG. 9 is a flowchart for explaining a method of identifying a driver according to one embodiment of the present disclosure.

Referring to FIG. 9, if the driver approaches the vehicle (operation S10), the automatic unparking apparatus 2000 may determine whether there is pre-stored driver's body information (operation S20).

After operation S20, if there is no driver registration information (No in operation S20), the automatic unparking apparatus 2000 may collect driver's body information using the vehicle sensors (operation S60).

On the other hand, after operation S20, if there is driver registration information (Yes in operation S20), the automatic unparking apparatus 2000 may perform primary driver identification using a driver's smartphone or smart key (operation S30).

After operation S30, the automatic unparking apparatus 2000 may perform secondary driver identification using the face recognition information and/or the stride recognition information (operation S40).

After operation S40, the automatic unparking apparatus 2000 may activate the stored body information data of the driver whose secondary identification has been completed (operation S50). Thereafter, the automatic unparking apparatus 2000 may control the automatic unparking operation based on the activated body information data.

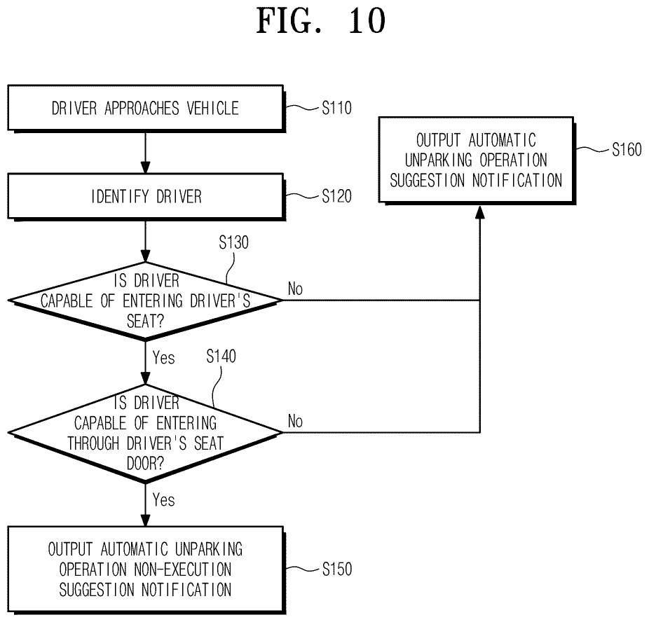

FIG. 10 is a flowchart for explaining a method of operating the automatic unparking operation, in accordance with one or more embodiments.

Referring to FIG. 10, if a driver approaches the vehicle (operation S110), the automatic unparking apparatus 2000 may identify the driver (operation S120).

After operation S120, the automatic unparking apparatus 2000 may determine whether the driver is capable of entering the driver's seat based on the identified driver's body information (operation S130). For this purpose, the automatic unparking apparatus 2000 may compare the identified driver's body size with a distance between the vehicle and an obstacle.

After operation S130, if the driver is capable of entering the driver's seat (Yes in operation S130), the automatic unparking apparatus 2000 may determine whether the driver is capable of entering through the driver's seat door (operation S140). For this purpose, the automatic unparking apparatus 2000 may compare the identified driver's body size with the opening angle of the driver's seat door.

After operation S140, if the driver is capable of entering through the driver's seat door (Yes in operation S140), the automatic unparking apparatus 2000 may output the automatic unparking operation non-execution suggestion notification (operation S150). Here, the automatic unparking apparatus 2000 may output an automatic unparking operation non-execution suggestion notification through at least one of a driver's smartphone or a smart key.

On the other hand, after operation S130, if the driver is not capable of entering the driver's seat (No in operation S130), the automatic unparking apparatus 2000 may output an automatic unparking operation suggestion notification through at least one of the driver's smartphone or smart key (S160).

In addition, after operation S140, if the driver is not capable of entering through the driver's seat door (No in operation S140), the automatic unparking apparatus 2000 may output an automatic unparking operation suggestion notification through at least one of the driver's smartphone or smart key (operation S160).

That is, the technical idea of the one or more examples is applicable to the entirety of an autonomous vehicle or is applicable to some devices in the autonomous vehicle. The scope and range of the one or more examples should be determined depending on the matters described in the claims.

As another aspect of the one or more examples, operation of the above-described examples may be provided as code that may be implemented, practiced, or executed by “computers” (a comprehensive concept including a system on chip (SoC), a microprocessor, or the like), an application that stores or includes the code, a computer readable storage medium, or a computer program product, and this also falls within the scope of the present disclosure.

As is apparent from the above description, according to one or embodiments, a space through which a driver is capable of boarding a vehicle may be determined using a driver's body size and distance information to neighboring vehicles and/or obstacles, thereby being capable of saving time necessary for the automatic unparking operation.

In addition, the vehicle may be effectively operated by not using the automatic unparking operation depending on confirmation of the space through which the driver is capable of boarding the vehicle.

Effects obtainable from the one or more examples are not limited to the above-mentioned effects, and other unmentioned effects can be clearly understood from the above description by those having ordinary skill in the technical field to which the one or more examples pertain.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An automatic unparking apparatus, comprising:
a camera sensor configured to obtain body information of a driver by measuring a shape of the driver's body;
a distance sensor configured to detect an object located around a vehicle, and measure a distance from the vehicle to the detected object;
a communication device configured to transmit and receive signals with a smart key corresponding to the vehicle;
a controller configured to identify a driver approaching the vehicle, determine whether the driver can enter a driver's seat of the vehicle, determine whether the driver can enter through a driver's seat door of the vehicle based on a determination that the driver can enter the driver's seat, and provide an automatic unparking operation suggestion notification based on a determination that the driver cannot enter through the driver's seat door; and
a warning output device configured to output the automatic unparking operation suggestion notification.

2. The apparatus according to claim 1, wherein the controller is further configured to:
measure the body information of the driver with the camera sensor as the driver approaches the vehicle;
determine whether the measured driver's body information is present in pre-stored driver's body information;
primarily identify the driver with the smart key, upon determining that the measured driver's body information is present in the pre-stored driver's body information;
secondarily identify the driver based on at least one of driver's face recognition information and driver's stride recognition information obtained by the camera sensor; and
activate the pre-stored driver's body information based on the secondarily identified driver.

3. The apparatus according to claim 2, wherein the controller is further configured to collect and store the body information of the driver approaching the vehicle, based on a determination that the body information of the driver approaching the vehicle is not present in the pre-stored driver's body information.

4. The apparatus according to claim 1, wherein the controller is further configured to provide the automatic unparking operation suggestion notification based on a determination that the driver cannot enter the driver's seat.

5. The apparatus according to claim 1, wherein the controller is further configured to provide an automatic unparking operation non-execution suggestion notification based on a determination that the driver can enter through the driver's seat door.

6. An automatic unparking method, comprising:
identifying a driver approaching a vehicle;
determining whether the driver can enter a driver's seat of the vehicle;
determining whether the driver can enter through a driver's seat door, based on a determination that the driver can enter the driver's seat; and
providing an automatic unparking operation suggestion notification, based on a determination that the driver cannot enter through the driver's seat door.

7. The method according to claim 6, wherein the identifying the driver approaching the vehicle comprises:
measuring body information of the driver approaching the vehicle with a camera sensor;
determining whether the measured driver's body information is present in pre-stored driver's body information;
primarily identifying the driver with a smart key, upon determining that the measured driver's body information is present in the pre-stored driver's body information;
secondarily identifying the driver based on at least one of driver's face recognition information and driver's stride recognition information obtained by the camera sensor; and
activating the pre-stored driver's body information based on the secondarily identified driver.

8. The method according to claim 7, further comprising collecting and storing the body information of the driver approaching the vehicle, based on a determination that the body information of the driver approaching the vehicle is not present in the pre-stored driver's body information.

9. The method according to claim 6, further comprising providing the automatic unparking operation suggestion notification, based on a determination that the driver cannot enter the driver's seat.

10. The method according to claim 6, further comprising providing an automatic unparking operation non-execution suggestion notification based on a determination that the driver can enter through the driver's seat door.
